(19) United States
(12) Patent Application Publication
(10) Pub. No.: US 2020/0135035 A1
(43) Pub. Date: Apr. 30, 2020

(54) INTELLIGENT ON-DEMAND CAPTURING OF A PHYSICAL ENVIRONMENT USING AIRBORNE AGENTS

(71) Applicant: Foresight AI Inc., Los Gatos, CA (US)

(72) Inventors: Chang YUAN, Los Gatos, CA (US); Zhaoyi WEI, San Jose, CA (US); Chih-Hsiang CHANG, Sunnyvale, CA (US)

(21) Appl. No.: 16/541,950

(22) Filed: Aug. 15, 2019

Related U.S. Application Data
(60) Provisional application No. 62/751,227, filed on Oct. 26, 2018.

(51) Int. Cl. G08G 5/00; G05D 1/04; G05D 1/12; B64C 39/02

(52) U.S. Cl. CPC G08G 5/0069; G05D 1/042; G08G 5/0034; B64C 2201/141; B64C 39/024; B64C 2201/027; B64C 2201/12; G05D 1/12

(57) ABSTRACT

The present invention generally relates to deploying airborne agents to capture data related to a physical environment. An exemplary device comprises one or more processors; a memory; and one or more programs that includes instructions for: receiving a user request indicative of a geographical region and a data type; in response to receiving the user request, generating a flight path based on the region; causing the airborne agent to traverse at least a portion of the region based on the generated flight path; causing the airborne agent to gather data based on the data type in the user request; processing the gathered data to obtain a set of data of interest; and providing an output based on the set of data of interest.

### CROSS-REFERENCE TO RELATED APPLICATION

This application claims the benefit of U.S. Provisional Application 62/751,227, filed on Oct. 26, 2018, the entire content of which is incorporated herein by reference for all purposes. This application relates to U.S. Provisional Patent Application Ser. No. 62/727,986, entitled “INTELLIGENT CAPTURING OF A DYNAMIC PHYSICAL ENVIRONMENT,” filed Sep. 6, 2018, the content of which is hereby incorporated by reference in its entirety for all purposes.

### FIELD OF THE INVENTION

The present disclosure relates generally to intelligent deployment of airborne agents (e.g., drones), and more specifically to systems and methods for deploying airborne agents to capture data related to a physical environment on demand.

### BACKGROUND

A physical environment can include static objects (e.g., roads, vegetation, lane markings, traffic signs) as well as dynamic objects (e.g., vehicles, pedestrians) and dynamic events (e.g., collisions, illegal activities). Currently, a variety of platforms, entities, and tools need to be involved to fully capture such a physical environment. For example, road data is usually captured using GPS systems by map services, while traffic data is often captured using traffic cameras. Further, because of the inconsistencies among the types and qualities of data captured, it is difficult to interpret and present the data in a coherent and precise manner. Additionally, much of the data related to a physical environment cannot be generated on demand. For example, to update map data, significant resources must be used to procure and deploy the necessary equipment, gather the data, and process the data. As another example, to study traffic patterns, a different set of resources may be needed to obtain the right data and process the data to extract information of interest.

Thus, there is a need for a platform that can receive requests for high-fidelity data (e.g., data related to a physical environment and objects/events in the physical environment) on demand and automatically fulfill the requests in an efficient, scalable, and intelligent manner.

### BRIEF SUMMARY

In some embodiments, a computer-enabled method for deploying an airborne agent to capture data related to a physical environment comprises receiving a user request indicative of a geographical region and a data type; in response to receiving the user request, generating a flight path based on the region; causing the airborne agent to traverse at least a portion of the region based on the generated flight path; causing the airborne agent to gather data based on the data type in the user request; processing the gathered data to obtain a set of data of interest; and providing an output based on the set of data of interest.

An exemplary electronic device comprises: one or more processors; a memory; and one or more programs, wherein the one or more programs are stored in the memory and configured to be executed by the one or more processors, the one or more programs including instructions for: receiving a user request indicative of a geographical region and a data type; in response to receiving the user request, generating a flight path based on the geographical region; causing the airborne agent to traverse at least a portion of the geographical region based on the generated flight path; causing the airborne agent to gather data based on the data type in the user request; processing the gathered data to obtain a set of data of interest; and providing an output based on the set of data of interest.

An exemplary non-transitory computer-readable storage medium stores one or more programs, the one or more programs comprising instructions, which when executed by one or more processors of an electronic device having a display, cause the electronic device to: receive a user request indicative of a geographical region and a data type; in response to receiving the user request, generate a flight path based on the geographical region; cause the airborne agent to traverse at least a portion of the geographical region based on the generated flight path; cause the airborne agent to gather data based on the data type in the user request; process the gathered data to obtain a set of data of interest; and provide an output based on the set of data of interest.

### DESCRIPTION OF THE FIGURES

FIG. 1 depicts a system for providing on-demand collection, processing, and visualization of data related to a physical environment with the aid of airborne agents, in accordance with some embodiments.

FIG. 2 depicts a process for providing on-demand data collection, processing, and visualization of data related to a physical environment with the aid of airborne agents, in accordance with some embodiments.

FIG. 3A depicts a user interface of the system, in accordance with some embodiments.

FIG. 3B depicts a user interface of the system, in accordance with some embodiments.

FIG. 3C depicts a user interface of the system, in accordance with some embodiments.

FIG. 3D depicts a user interface of the system, in accordance with some embodiments.

FIG. 3E depicts a user interface of the system, in accordance with some embodiments.

FIG. 3F depicts a user interface of the system, in accordance with some embodiments.

FIG. 3G depicts a user interface of the system, in accordance with some embodiments.

FIG. 3H depicts a user interface of the system, in accordance with some embodiments.

FIG. 3I depicts a user interface of the system, in accordance with some embodiments.

FIG. 3J depicts a user interface of the system, in accordance with some embodiments.

FIG. 4A depicts an exemplary process for obtaining flight instructions based on a data request, in accordance with some embodiments.

FIG. 4B depicts a plurality of flight paths for an airborne agent, in accordance with some embodiments.

FIG. 4C depicts a flight path for an airborne agent, in accordance with some embodiments.

FIG. 4D depicts an estimated area of coverage for an exemplary flight path, in accordance with some embodiments.

FIG. 5A depicts an exemplary process for generating a high-fidelity map of a physical environment and static objects in the physical environment, in accordance with some embodiments.

FIG. 5B depicts an exemplary process for intelligently selecting gathered data for further processing, in accordance with some embodiments.

FIG. 5C depicts an exemplary process for intelligently selecting gathered data for further processing, in accordance with some embodiments.

FIG. 6 depicts process 600 for deploying an airborne agent to capture data related to a physical environment, according to various examples.

FIG. 7 depicts an exemplary electronic device in accordance with some embodiments.

### DETAILED DESCRIPTION

Provided are systems and methods for receiving requests for high-fidelity data (e.g., data related to a physical environment and objects and events in the environment) on demand and automatically fulfilling the requests in an efficient, scalable, and intelligent manner. As discussed below, an exemplary platform includes one or more airborne agents (e.g., drones) and techniques for intelligent flight path generation, intelligent data collection/selection, intelligent data processing, and a streamlined user interface for requesting and visualizing the data. The platform produces rich, high-fidelity, and correlated information about the physical environment and the objects/events in the physical environment.

Data produced by the system can be used by human users and robot users for a variety of purposes. For example, the data can include up-to-date knowledge of the physical environments (e.g., new lane markings) and thus can be used to provide accurate and up-to-date navigation guidance of the physical environment. Further, the data can be used to train algorithms to improve the driving capabilities of autonomous vehicles. Further, the data can be used to aid predictive analytics (e.g., of traffic patterns, of human behaviors). The knowledge of real-world events, patterns, and interactions can be valuable data for urban planning (e.g., operation of traffic lights). Further, the data can be used to detect and respond to real-world events. For example, the system can automatically detect accidents and deploy drones to send emergency supplies. As another example, the system can monitor an environment (e.g., a port, a warehouse) and alert authorities when anomalies are detected.

The following description sets forth exemplary methods, parameters, and the like. It should be recognized, however, that such description is not intended as a limitation on the scope of the present disclosure but is instead provided as a description of exemplary embodiments.

Although the following description uses terms “first,” “second,” etc. to describe various elements, these elements should not be limited by the terms. These terms are only used to distinguish one element from another. For example, a first sensing device could be termed a second sensing device, and, similarly, a second sensing device could be termed a first sensing device, without departing from the scope of the various described embodiments. The first sensing device and the second sensing device are both sensing devices, but they are not the same sensing device.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

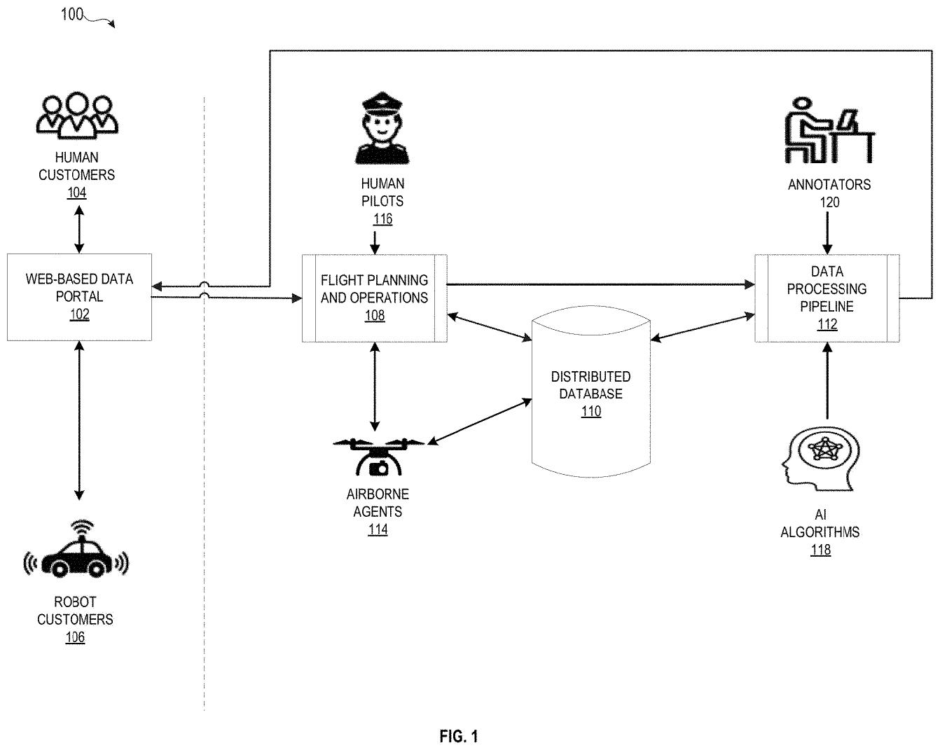

FIG. 1 depicts a system 100 for providing on-demand collection, processing, and visualization of data related to a physical environment with the aid of airborne agents, in accordance with some embodiments. The data can be static or dynamic. Static data includes data representing a physical environment and data representing the stationary objects (e.g., roads, buildings, traffic signs) in the physical environment. Dynamic data includes data representing dynamic objects (e.g., vehicles, pedestrians, riders) and dynamic scenarios/events (e.g., motions of all dynamic objects, traffic patterns, collisions, illegal activities).

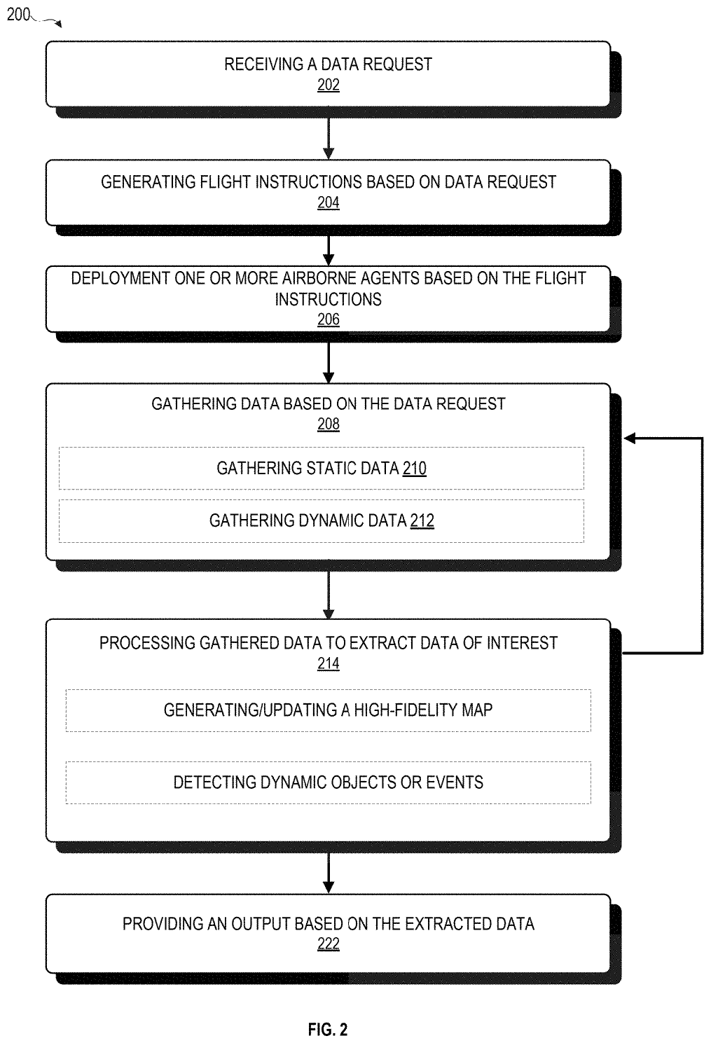

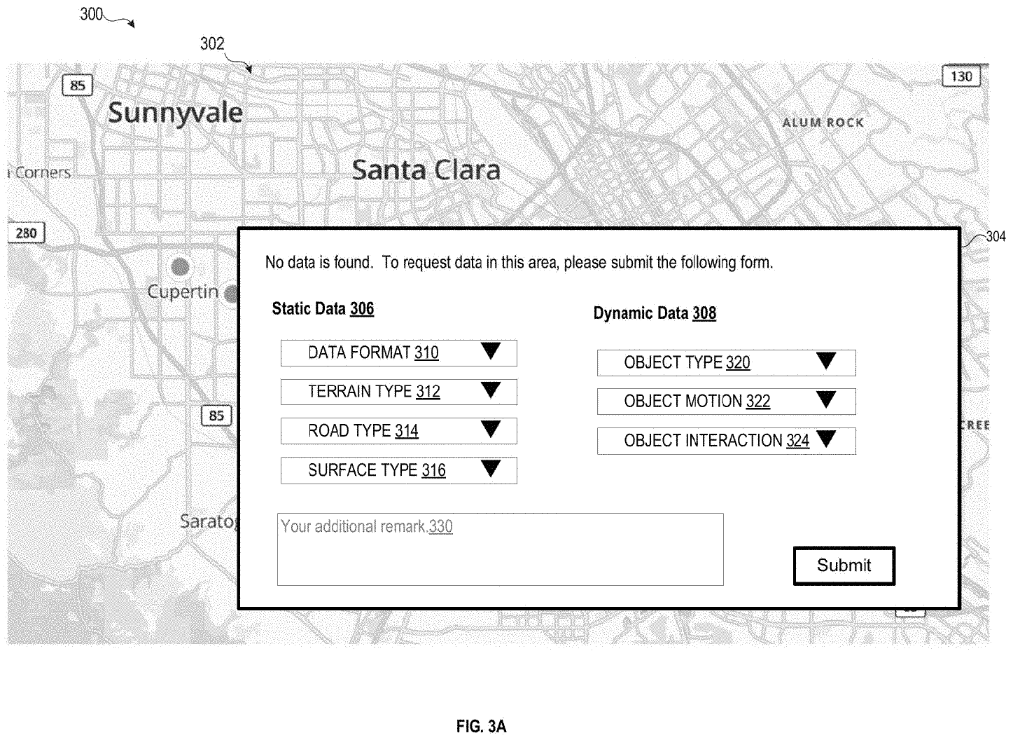

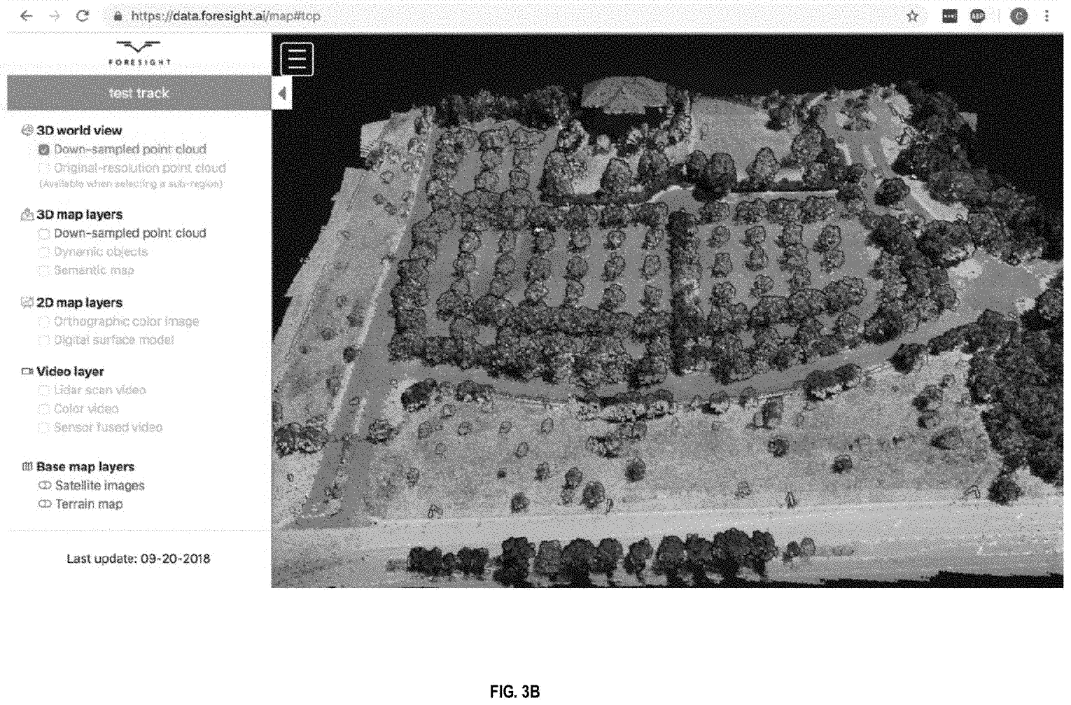

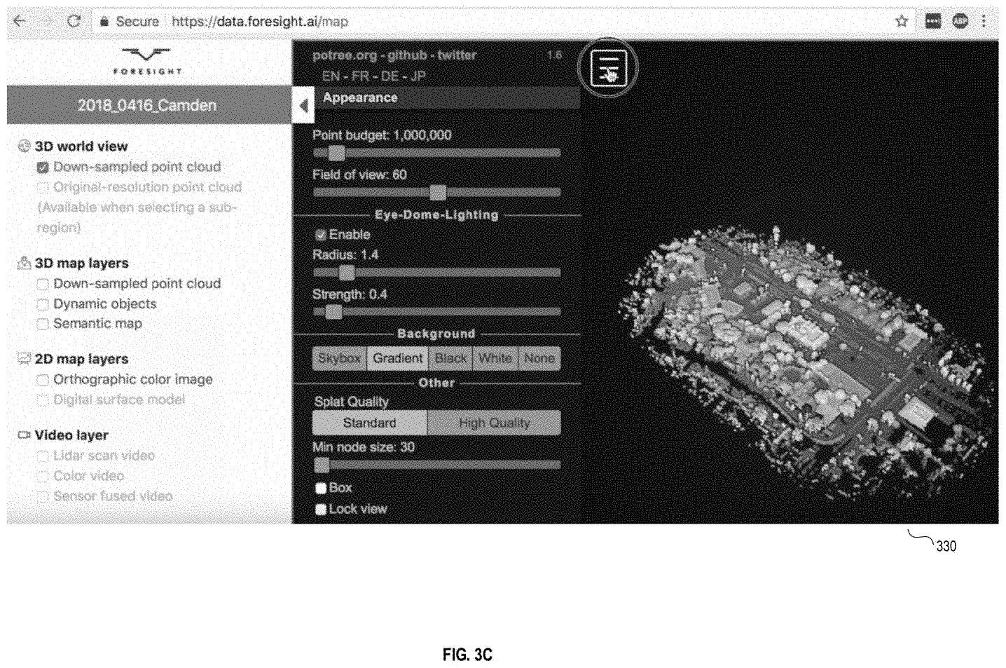

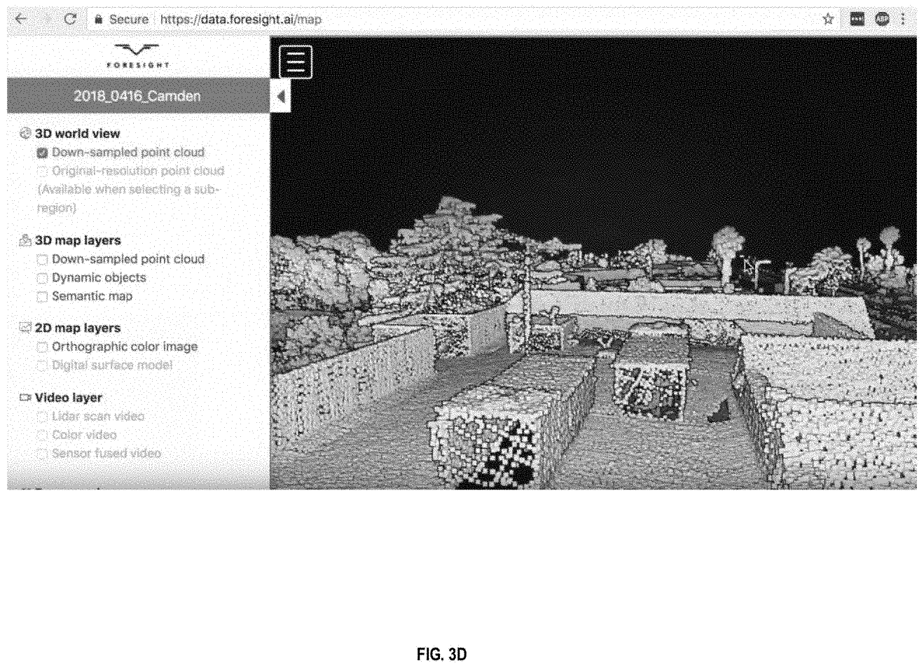

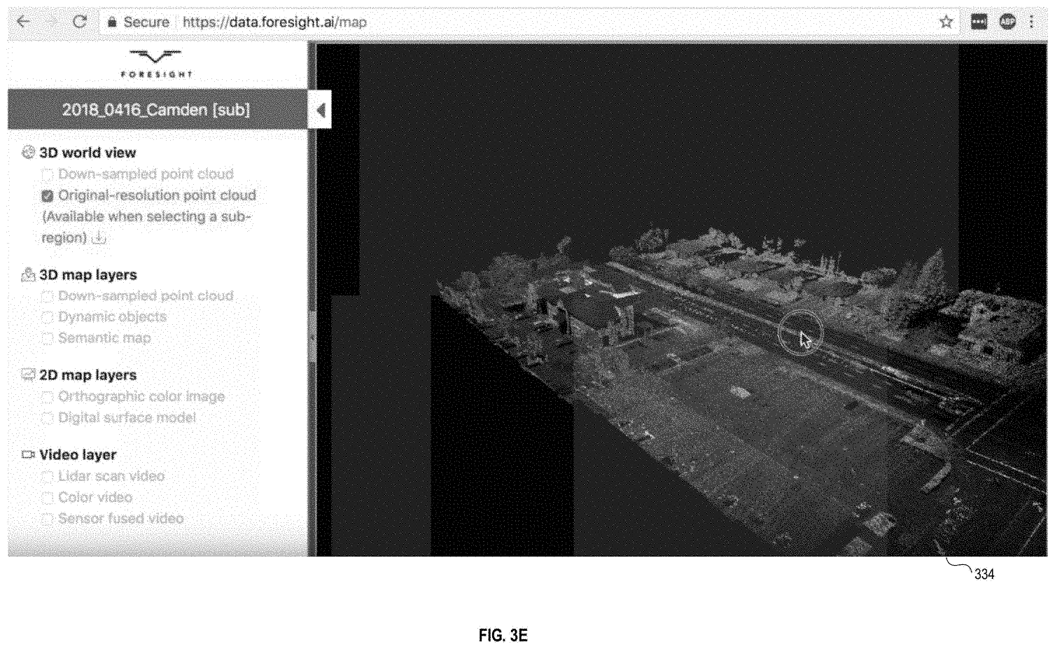

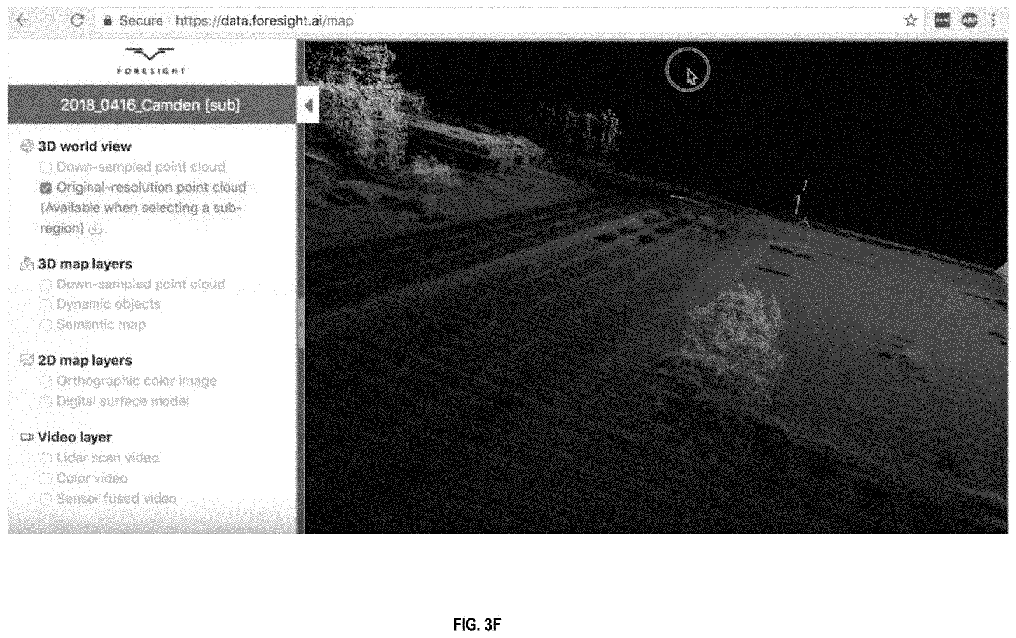

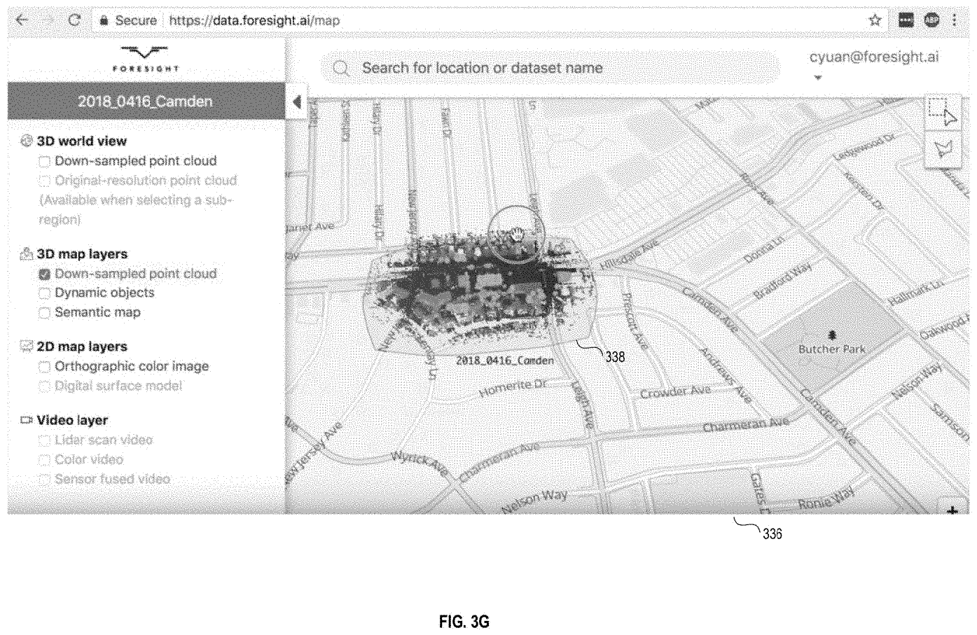

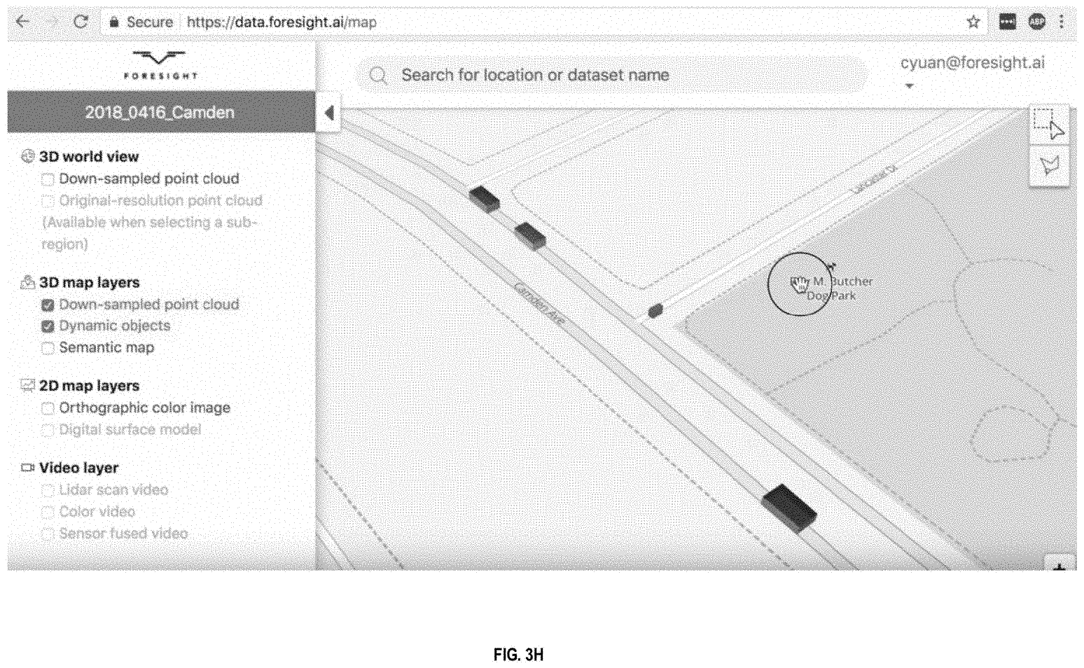

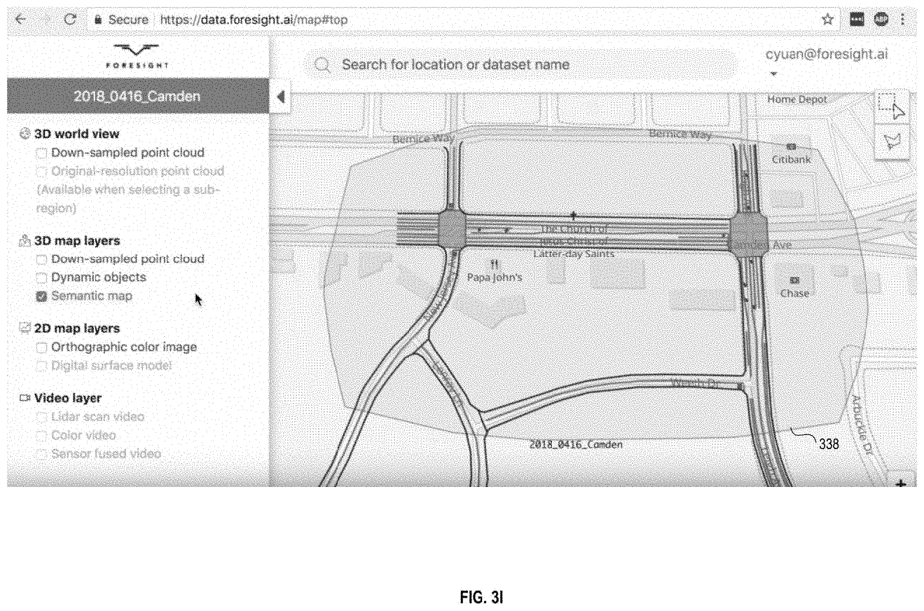

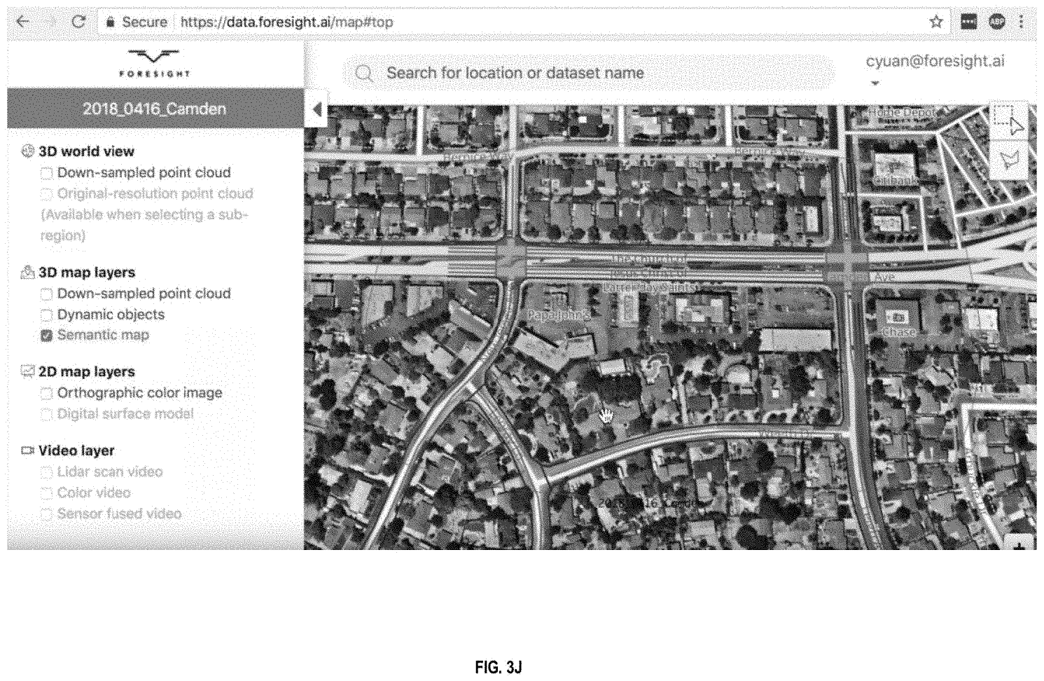

The system 100 includes a web portal 102, through which users of the system 100 can submit data requests, track the status of the data requests, view the requested data, and submit follow-up requests. Users of the system include human users 104 and robot users 106 (e.g., autonomous vehicles). For example, a human user (e.g., an engineer) can access the web portal 100 and submit a request to view an ortho-image of a particular neighborhood or view accidents at a particular intersection on a particular date. Exemplary graphical user interfaces of the web portal 100 are described in detail with reference to FIG. 2 and FIGS. 3A-J.

The robot user 106 is communicatively coupled to the system 100, for example, via a wireless network, such that the robot user can transmit data requests to the system 100 and receive the requested data. For example, a robot user (e.g., an autonomous vehicle) can transmit a request for “pedestrians' behavior around T intersections in Palo Alto, Calif.” and receive from the system 100 one or more sets of data accordingly.

Data gathered by the system 100 can be used by the human users 104 and the robot users 106 for a variety of purposes. For example, the data can include updates in the physical environment (e.g., new lane markings) and thus can be used to provide accurate and up-to-date navigation guidance of the physical environment. Further, the data can be used to train algorithms to improve the driving capabilities of autonomous vehicles. Further, the data can be used to aid predictive analytics (e.g., of traffic patterns, of human behaviors). The knowledge of real-world events, patterns, and interactions can be valuable data for urban planning (e.g., operation of traffic lights). The data can be used to detect and respond to real-world events. For example, the system can automatically detect accidents and deploy drones to send emergency supplies. As another example, the system can monitor an environment (e.g., a port, a warehouse) and alert authorities when anomalies are detected.

With reference to FIG. 1, the system 100 includes process(es) 108 for performing flight planning and operations. The flight instructions are used to direct one or more airborne agents to traverse the specified geographical location to gather data. In some embodiments, the airborne agents include one or more drones. The flight instructions are generated based on the data request received at the web portal 102 (e.g., location specified in the data request).

The system 100 includes a distributed database 110. The distributed database 110 can provide information needed to generate flight instructions to direct airborne agents to gather data efficiently and accurately. Further, the distributed database 110 can provide information needed for the data processing pipeline 112 to process the gathered data and extract data of interest. Further still, the distributed database 110 can store the extracted data in order to fulfill future data requests.

In some embodiments, the distributed database 110 stores geographical information such as the local civil structures (e.g., roads, buildings, vegetation), traffic information (e.g., local live traffic information), local event information (e.g., gathering), and local environmental information (e.g., weather, time). These information can be obtained or derived from external sources (e.g., third-party service providers that provide weather information or map information), the airborne agents, the data processing pipeline, or a combination thereof.

In some embodiments, the distributed database 110 can reside on one or more local data centers, a central data center, the cloud, or a combination thereof. The local data centers can have local storage and can communicate with each other. In some embodiments, the local data centers are geographically distributed. These local data centers can be existing data facilities, such as facilities of wireless service providers, depending on the data throughput, latency requirement, and the area covered. In some embodiments, the information stored at the local data centers is synced to the cloud. In some embodiments, some information stored at the local data centers (e.g., license plates, human faces) is not synced on the cloud but stored only locally for latency and privacy considerations.

Generation of the flight instructions can be performed at the local data centers hosting the distributed database 110, the one or more airborne agents 114, a separate set of devices, or a combination thereof. In some embodiments, the generation of flight instructions involves the collaboration between the data centers and the airborne agents. In some embodiments, the airborne agents receive a set of precise flight instructions (e.g., specifying flight coordinates, trajectories, directions, speed, time stamps) and thus need to perform minimal calculation before and/or during flight. In some embodiments, the airborne agents receive high-level instructions (e.g., a flight route including a set of checkpoints) and thus need to calculate the precise flight instructions before and/or during flight. During flight, the data centers and the airborne agents can communicate to generate updated flight instructions as necessary. In some examples, the airborne agents receive only a high-level goal (e.g., specifying the region and the type of data to be gathered) and thus need to generate the necessary flight instructions. In some embodiments, one or more human pilots 116 can formulate part of the flight instructions, which are transmitted to the airborne agents before and/or during flight.

With reference to FIG. 1, the system further comprises data processing pipeline 112 to process the gathered data and extract data of interest from the gathered data. The data processing pipeline 112 can be implemented by the airborne agents, the local data centers, the central data center, the cloud, or a combination thereof. As depicted, the data processing pipeline 112 can incorporate artificial intelligence algorithms 118, which are described below. Additional exemplary artificial intelligent algorithms 118 are provided in U.S. Provisional Patent Application 62/727,986, entitled “INTELLIGENT CAPTURING OF A DYNAMIC PHYSICAL ENVIRONMENT,” filed Sep. 6, 2018, the content of which is hereby incorporated by reference in its entirety for all purposes.

The data processing pipeline 112 can further incorporate intervention by human annotators 120. In some embodiments, a local data center aggregates the map update information from all the agents over a temporal period. The transient changes over the temporal period are filtered out and the consistent changes are packaged and sent to the annotators 120. In some embodiments, the system automatically detects semantic types (e.g., traffic signs, lane markings, and road boundaries) in the gathered data, and only sends a portion (e.g., a fixed percentage, a portion having low confidence scores) of the detected semantic types to human annotators 120 for verification. In some embodiments, the system deploys one or more airborne agents to the geographical region to verify or recapture data before requesting intervention by human annotators 120.

In some embodiments, in addition to airborne agents, other agents such as vehicles, pedestrians, and bikers can gather data and provide the gathered data to the system (e.g., by transmitting the data to a nearby local data center). The data gathered by these agents can include location data (e.g., GPS signals of a pedestrian), motion data (e.g., movement of a vehicle), and image data (e.g., a photo captured by the pedestrian). The data gathered by these agents can be integrated into the data processing pipeline. Depending the hardware and software used by the other moving agents, the other moving agent may gather only lower-fidelity data. The lower-fidelity data (e.g., location and motion of a vehicle) can be refined in the airborne agent's observation frame and the refined data (e.g., more precise location and motion data) can be stored by the system (e.g., stored at a local data center). In some embodiments, the data gathered by the moving agents can be used to filter the moving objects from the data gathered by the airborne agents, when necessary.

After the data processing pipeline 112 extracts data of interest, the data of interest can be displayed via the web portal 102. Subsequently, the users of the system 100 can view the data in different formats or visualization settings and submit follow-up requests, as discussed below. In some embodiments, when the data request is submitted by a robot user, the system automatically transmits the data of interest to the robot user.

FIG. 2 depicts an exemplary process 200 for providing on-demand data collection, processing, and visualization of data related to a physical environment with the aid of airborne agents, in accordance with some embodiments. Process 200 is performed, for example, using one or more electronic devices. In some examples, the blocks of process 200 are divided up in any manner among the one or more electronic devices performing process 200. In some examples, the one or more electronic devices include the one or more electronic devices hosting a web portal (e.g., web portal 102 of FIG. 1), devices hosting a database (e.g., the distributed database 110 of FIG. 1), devices hosting a data processing pipeline (e.g., the data processing pipeline 112 of FIG. 1), and additional electronic devices that are communicatively coupled with each other. Thus, while portions of process 200 are described herein as being performed by particular devices, it will be appreciated that process 200 is not so limited. In process 200, some blocks are, optionally, combined, the order of some blocks is, optionally, changed, and some blocks are, optionally, omitted. In some examples, additional steps may be performed in combination with the process 200. Accordingly, the operations as illustrated (and described in greater detail below) are exemplary by nature and, as such, should not be viewed as limiting.

At block 102, a system (e.g., the system 100 of FIG. 1) receives a data request from a user of the system. As discussed above, the user can be a human user (e.g., human customers 104 of FIG. 1), who can submit the data request via a user interface provided by a software application (e.g., web portal 102 of FIG. 1). The user can also be a machine user (e.g., robot customers 106 of FIG. 1), who can submit the data request via a communication channel (e.g., a wireless network).

FIG. 3A depicts an exemplary user interface 300 for submitting a data request, in accordance with some embodiments. The user interface 300 displays a map interface 302. A user can interact with the map interface 302 to specify a geographical region to request data from. For example, the user can search for a location, zoom in, zoom out, or select a location on the map interface 302.

The user interface 300 further includes a dialog box 304 for specifying the data to be requested. The dialog box 304 includes a plurality of user affordances (e.g., multi-level drop-down menus) for specifying attributes of the requested data according to a predefined data taxonomy. In the depicted example, the data taxonomy includes static data 306, which refers to data representing the physical environment and the static objects in the physical environment, and dynamic data, which refers to data representing the dynamic objects or events in the physical environment.

For static data 306, the dialog box 304 allows the user to specify a data format 310, a terrain type 312, a road type 314, and a surface type 316, according to an exemplary taxonomy. Exemplary data formats 310 include: 3D point cloud, 2D ortho-projected images, and 3D semantic map. Exemplary terrain types 312 include: local streets, highway, industrial park, farm land, water areas (e.g., river, lake). Exemplary road types 314 includes: straight road, curvy road, 4-way signaled intersection, 3-way signaled intersection, 4-way stop, 3-way stop, and roundabout. Exemplary surface types 316 include paved, unpaved, mountain, swamp, and beach.

For dynamic data, the dialog box 304 allows the user to specify an object type 320, an object motion 322, and a multi-object interaction 324, according to an exemplary taxonomy. Exemplary object types 320 include: small vehicles (which may be further categorized into sedan, coupe, cross over, two wheelers, bicycle, motorcycle, etc.), large vehicles (which may be further categorized into SUV, van, bus, truck, etc.), and human (which may be further categorized into pedestrian, rider, etc.). Exemplary object motions 322 include: vehicle motion (which may be further categorized into straight motion, left turn, right turn, U-turn, roundabout turn, merging onto highway, illegal turn, etc.) and human motion (which may be further categorized into walking on sidewalk, sitting on the sidewalk, crossing street, walk on the street, jaywalking, etc.). Exemplary multi-object interactions 324 include: following, passing, towing, rear-end crashing and head-on crashing.

In some embodiments, the user interface 300 allows the user to further narrow the data request by additional parameters such as time period, traffic volume, and weather condition. In some embodiments, the user interface 300 allows the user to specify logic relationships among the attributes in the data request. For example, the user can request data related to “all Toyota Camrys or Toyota Corolla making U-turns at a particular intersection in Sunnyvale, Calif. at 8-10 AM on week days”. The user interface 300 can also allow the user to specify customized data of interest that is not included in the default taxonomy. For example, a user can specify a customized data request to identify manholes of a particular size in a particular geographical region, even if manholes are not defined the default taxonomy of the system. Customized data requests can be submitted via the user interface 300 (e.g., via the text box 330), for example. In some embodiments, the system supports a plurality of taxonomies (e.g., traffic data, port data), and the user interface 300 allows the user to select a particular taxonomy before further specifying attributes of data to be requested.

Turning back to FIG. 2, at block 204, the system generates flight instructions based on the data request. The flight instructions are used to direct one or more airborne agents, such as drones, to travel to and traverse geographical region(s) of interest to gather data. As discussed above, the generation of flight instructions can be divided among the one or more airborne agents, the one or more local data centers, one or more human pilots, the cloud, or any combination thereof. In some examples, a local data center generates a set of precise flight instructions (e.g., specifying flight coordinates, trajectories, directions, speed, time stamps) for an airborne agent to follow. In some examples, the local data center provides high-level instructions (e.g., a flight route including a set of checkpoints) to the airborne agent and further provides live feedback to the airborne agent during flight. In some examples, the local data center provides only a high-level goal (e.g., specifying the region and the type of data to be gathered) and instructs the airborne agent to generate the necessary flight instructions.

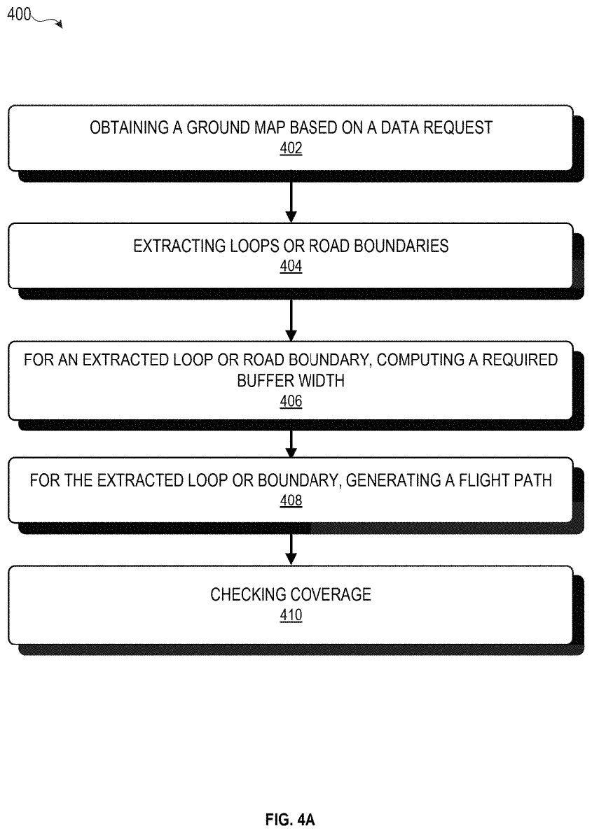

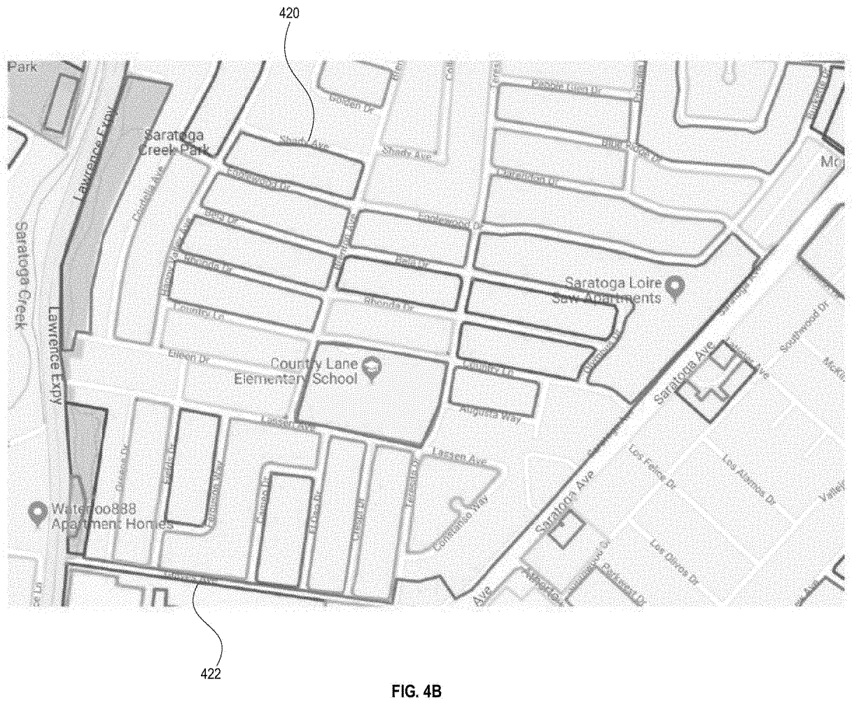

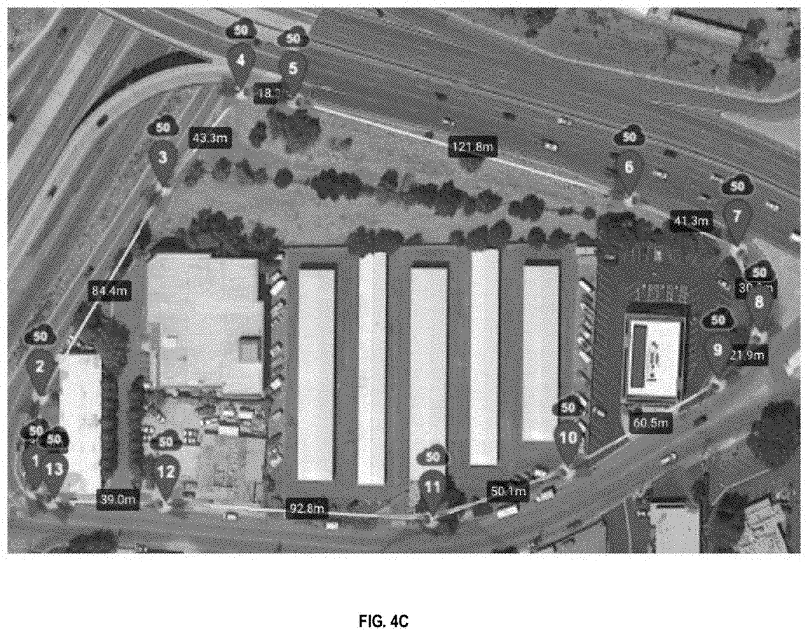

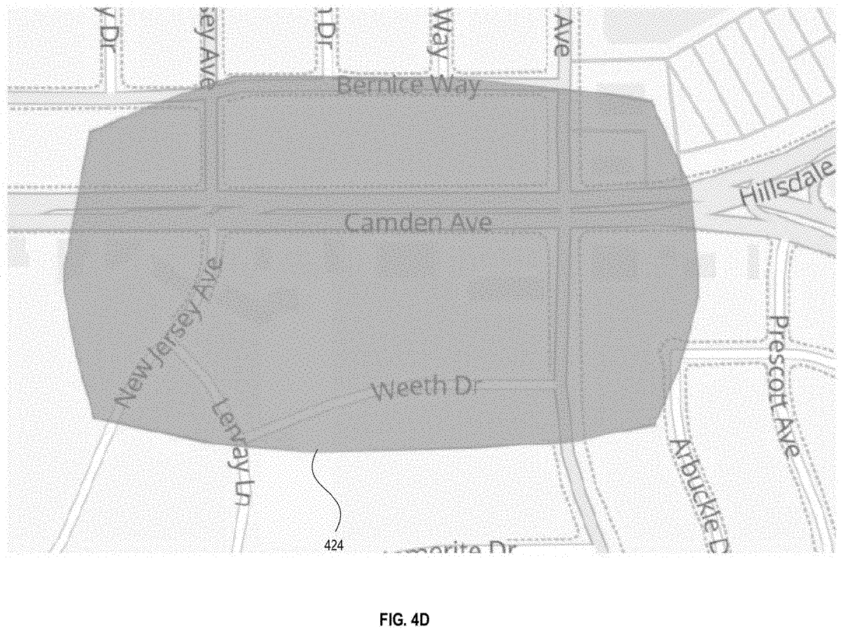

FIG. 4A depicts an exemplary process for obtaining flight instructions based on a data request, in accordance with some embodiments. Process 400 is performed, for example, using one or more electronic devices. In some examples, the blocks of process 400 are divided up in any manner among the one or more electronic devices performing process 400. In some examples, the one or more electronic devices include the one or more electronic devices hosting a web portal (e.g., web portal 102 of FIG. 1) or a database (e.g., the distributed database 110 of FIG. 1), one or more airborne agents (e.g., the airborne agents 114 of FIG. 1), and/or additional electronic devices that are communicatively coupled with each other. Thus, while portions of process 400 are described herein as being performed by particular devices, it will be appreciated that process 400 is not so limited. In process 400, some blocks are, optionally, combined, the order of some blocks is, optionally, changed, and some blocks are, optionally, omitted. In some examples, additional steps may be performed in combination with the process 400. Accordingly, the operations as illustrated (and described in greater detail below) are exemplary by nature and, as such, should not be viewed as limiting.

At block 402, the system obtains a ground map based on a data request. For example, based on the geographical region specified in the data request, the system can obtain a high-fidelity map from the distributed database (e.g., from a local data center). If the high-fidelity map is not available from the distributed database, the system can download a ground map (e.g., OpenStreetMap) corresponding to the specified geographical region. Thus, the ground map used in process 400 can be a high-fidelity map or a low-fidelity map.

At block 404, the system extracts the loops and/or road boundaries from the obtained ground map. In some embodiments, the system first identifies closed loops from the map. For an open road segment that is not part of a closed loop, the system identifies the boundaries of the open road segment (e.g., beginning, end, edges of the segment). FIG. 4B depicts a plurality of flight paths generated according to process 400. As shown, the flight paths include both closed loops (e.g., loop 420) and open road segments that are not part of closed loops (e.g., road segment 422).

At block 406, the system computes a required buffer width to be maintained between the airborne agent and the edge of a road. In some embodiments, the airborne agent may not be allowed to fly directly over the road, and thus flies beside the road but maintains a buffer width such that the airborne agent is still close enough to the road to gather data of the road surface. The buffer width can be determined based on the required accuracy, road coverage, standard altitude, camera specifications (field of view), or a combination thereof. An exemplary buffer width is around 2 meters from an edge of the road. FIG. 4C depicts an exemplary flight path generated according to process 400. As shown, the flight path is off the road but close to it.

At block 408, the system generates a flight path. Specifically, the system obtains sets of way points along the loops and/or road segments based on the computed buffer widths. Based on the set of way points, the system generates a flight path, for example, by doing interpolation between the way points. As shown in FIG. 4C, the flight path comprises a plurality of way points and specifies distances between the way points.

At block 410, the system checks the coverage of the generated flight path. The coverage can be calculated based on the camera specifications (e.g., point of view) and the flight path. FIG. 4D depicts an estimated area of coverage for an exemplary flight path.

After the system verifies that the generated flight paths cover the entire geographical region, one or more airborne agents can traverse the geographical region based on the generated flight paths to gather data.

Turning back to FIG. 2, at block 206, the system deploys one or more airborne agents (e.g., drones). The airborne agents traverse a geographical region based on the generated flight paths. In some embodiments, a single airborne agent can be deployed to traverse the flight paths. In some embodiments, multiple airborne agents can be deployed simultaneously to traverse the flight paths. Each airborne agent can be equipped with sensors capable of capturing three-dimensional data and/or two-dimensional data. A 3D sensor can sense a 3D position and/or velocity of a physical point, such as a LiDAR sensor module or a radar sensor module. A 2D sensor can sense capture 2D pixel array of the imagery around the sensor, such as a visible light camera, an IR camera, or a multi-spectrum camera. The airborne agent can be additionally equipped with one or more navigation sensors. The navigation sensor can include a combination of positioning sensor(s), such as a global positioning system (“GPS”), a Global Navigation Satellite System (“GLONASS”), a BeiDou Navigation Satellite System (“BDS”), and a barometer, as well as pose measurement system(s), such as an inertial measurement unit (“IMU”). In some embodiments, localization accuracy for sensors of the airborne agents can be <10 cm in position, and <1 Degree in orientation.

The system is able to deploy airborne agents having different hardware and software configurations. For example, a first airborne agent may be equipped with a first set of equipment (e.g., including high-fidelity 3D sensing devices such as LiDAR), while a second airborne agent may be equipped with a second set of equipment (e.g., excluding LiDAR equipment). As discussed below, the gathering of static data and the gathering of dynamic data may require different hardware and software configurations. For example, a LiDAR system is needed to obtain a high-fidelity 3D point cloud of a physical environment, but is not necessary to capture dynamic objects. Thus, based on the data to be gathered, different airborne agents may be selected and deployed. Further, the system can deploy the airborne agent(s) based on the physical proximity of the agent to the geographical region to be surveyed. For example, the system can deploy an airborne agent located at a local data center close to the region to be surveyed.

At block 208, the system gathers data based on the data request. During flight, the airborne agent(s) can adapt the flight paths based on real-time contextual information. In some embodiments, if the airborne agent encounters events that prevent the agent from gathering data efficiently, the agent may update the flight path accordingly. For example, if there is heavy traffic blocking the surface of a road or a red light preventing the agent from traveling forward, the agent may travel elsewhere and return at a later time. In some embodiments, the airborne agent may update its flight path based on environmental factors. For example, the airborne agent may update its flight path to avoid gathering data from a location when the location is experiencing excessive shadows. In some embodiments, the airborne agent can time the capturing of data. For example, in order to capture behavior of cars running yellow light, the airborne agent can plan its flight path and time the activation of sensors accordingly. In some embodiments, the airborne agent is programmed to handle unexpected scenarios. For example, when the airborne agent's battery level is below a threshold, the airborne agent can automatically detect what is underneath and travel to a location to minimize damage during landing.

As discussed above, the data requested may be static data (e.g., a 3D point cloud representing a geographical region) or dynamic data (e.g., traffic patterns at an intersection). As such, block 208 can comprise gathering static data (block 210), dynamic data (block 212), or a combination thereof.

In some embodiments, processing of dynamic data requires a preexisting high-fidelity map. If the system does not have a high-fidelity map for the specified geographical region, the system needs to gather static information needed to construct the map, even if the user has only requested dynamic data for the region. On the other hand, if the system already has a high-fidelity map for a region (e.g., stored at a nearby local data center hosting a portion of the distributed database), the system only needs to gather dynamic data specified in the user request. In some embodiments, if the system already has a high-fidelity map for a geographical region (e.g., stored at a nearby local data center) but the user has requested an update, the system needs to gather static information and identify updates to the map, if any.

At block 214, after data is gathered, the system processes the gathered data to extract data of interest. The processing can be performed by the one or more airborne agents gathering the data, the one or more local data centers, the cloud, or a combination thereof. Further, the processing can be performed during the flight of the airborne agents, after the flight of the airborne agents, or a combination thereof. Block 208 and block 214 may be performed simultaneously at the same device(s), in some examples.

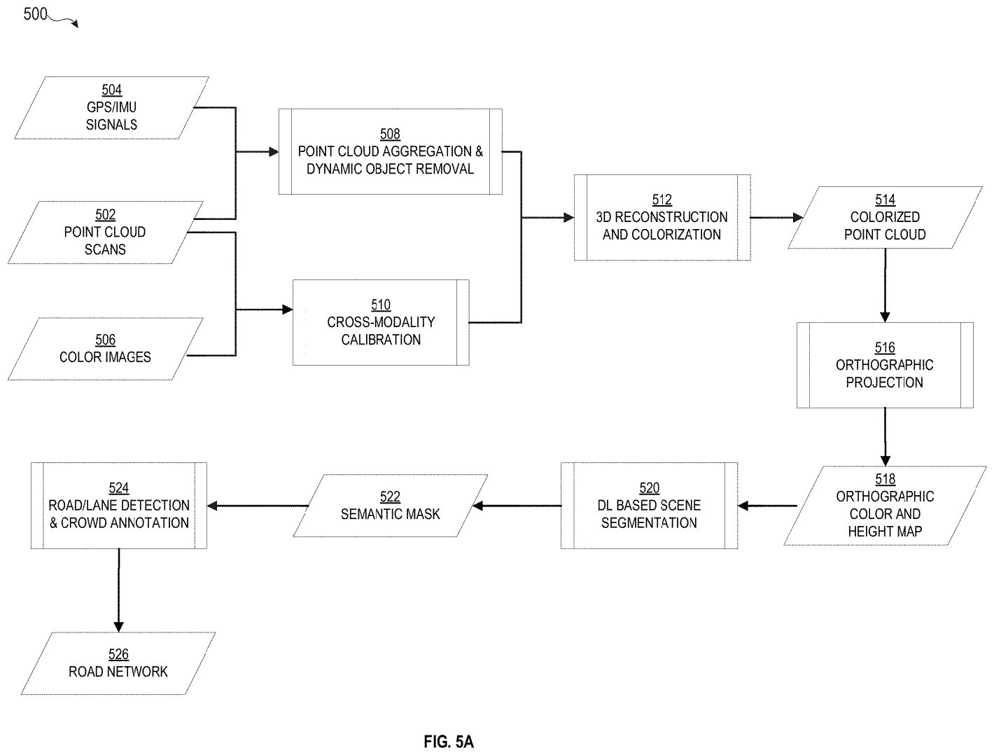

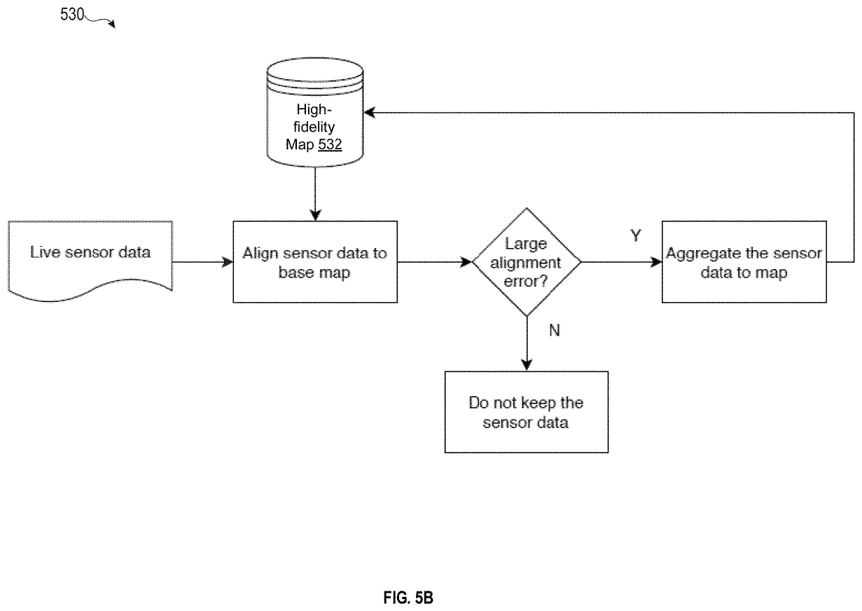

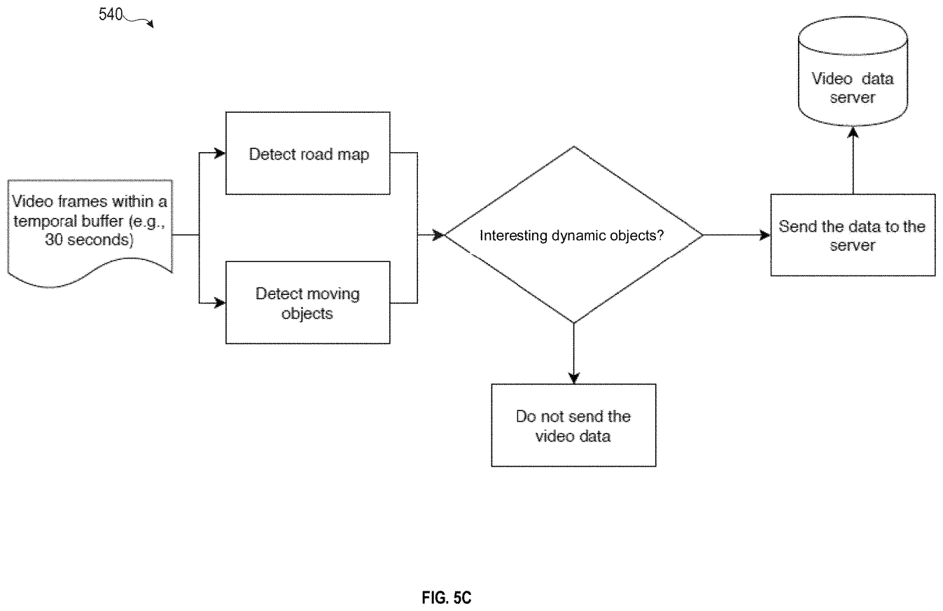

In some embodiments, block 214 may comprises generating a high-fidelity map, electing data for further processing, updating the high-fidelity map based on the selected data, extracting dynamic objects/scenarios based on the selected data, or a combination thereof. FIGS. 5A-C depict exemplary processes that can be performed as part of block 214.

FIG. 5A depicts an exemplary process for generating a high-fidelity map of a physical environment and static objects in the physical environment, in accordance with some embodiments. Process 500 is performed, for example, using one or more electronic devices. In some examples, the blocks of process 500 are divided up in any manner among the one or more electronic devices performing process 500. In some examples, the one or more electronic devices include one or more airborne agents, one or more local data centers, the cloud, and additional electronic devices that are communicatively coupled with each other. Thus, while portions of process 500 are described herein as being performed by particular devices, it will be appreciated that process 500 is not so limited. In process 500, some blocks are, optionally, combined, the order of some blocks is, optionally, changed, and some blocks are, optionally, omitted. In some examples, additional steps may be performed in combination with the process 500. Accordingly, the operations as illustrated (and described in greater detail below) are exemplary by nature and, as such, should not be viewed as limiting.

With reference to FIG. 5A, the data gathered by the airborne agents includes point cloud scans 502, GPS/IMU signals 504, and color images 506. The GPS/IMU signals 504 can include geographical data measured by the navigation sensors (e.g., GPS, IMU) of airborne agent. The point cloud scans 502 can include results from 3D scans performed by 3D sensors (e.g., LiDAR, radar) of the airborne devices. The color images 506 can include 2D data (e.g., 2D pixel array, videos) measured by the 2D sensors (e.g., cameras) of the airborne agents.

At block 508, the point cloud scans 502 and the GPS/IMU signals 504 are used to perform point cloud aggregation and data representing dynamic objects (e.g., cars, pedestrians) are identified as transient changes and removed from the point cloud. For example, the system can aggregate results from different 3D scans (e.g., at different times, by different 3D sensors) to construct a single point cloud. Further, the system can identify correlations between the point cloud scans 502 and the GPS/IMU data 504 to associate points in the point cloud with geographical information (e.g., longitude, latitude, elevation).

At block 510, the point cloud scans 502 and the color images 506 are used to perform cross-modality calibration. For example, the system can identify correlations between the point cloud scans 502 and the color images 506 to associate points in the point cloud with color information. In some embodiments, the correlations can be established based on the time stamps associated with the data and/or the known positioning of the sensors.

At block 512, 3D reconstruction and colorization are performed to obtain a colorized 3D point cloud 514. A colorized and geo-referenced 3D point cloud 514 representative of the physical environment surveyed by the airborne agents is obtained.

At block 516, orthographic projection is performed based on the colorized point cloud 514 to obtain an orthographic color map and a height map 518. At block 520, deep-learning based semantic segmentation is performed to identify predefined semantic types (or semantic mask 522) in the physical environment. The predefined semantic types can include objects of interest and shapes of interest, such as traffic signs, lane markings, and road boundaries. In some embodiments, the system can identify a portion of the map(s) to be associated with a predefined semantic type based on physical characteristics (e.g., color, shape, pattern, dimension, irregularity or uniqueness) of the pixels of the map(s). Further, the system can identify a portion of the map(s) to be associated with a predefined semantic type based on metadata (e.g., location) of the portion of the map(s). Further, the system can identify a portion of the map and/or assign a confidence value to the identification by analyzing the map measured at different times. In some embodiments, one or more neural network classifiers are used to identify predefined semantic types applicable to the maps.

In some embodiments, the identified semantic types are associated with the corresponding point(s) in the point cloud or the corresponding pixels in the maps as labels or annotations. In some embodiments, the identified semantic types form a tactical layer that can be referenced to other data in a 3D map dataset, such as the 3D point cloud.

At block 524, the semantic masks 522 are used to obtain roads or lanes. In some embodiments, the roads or lanes are represented as 3D vectors. As discussed above, annotations may be manually performed by human annotators. Accordingly, road network 526 is obtained. The road networks 526 can be stored in a distributed database. The maps generated by process 500 (e.g., 3D map, 2D color map, height map) include high-fidelity data (e.g., expected error is <10 CM, or even <4 CM). In some embodiments, a portion of the road networks can be stored at a local data center in proximity to the corresponding geographical location.

FIG. 5B depicts an exemplary process 530 for intelligently selecting gathered data for further processing to update a high-fidelity map 532, in accordance with some embodiments. The high-fidelity map 532 can be generated in accordance with process 500. Process 530 can be performed, for example, when the user requests for static information regarding a geographical region. Process 530 can also be performed periodically without explicit user requests. Process 530 is performed, for example, using one or more electronic devices. In some examples, the blocks of process 500 are divided up in any manner among the one or more electronic devices performing process 530. In some examples, the one or more electronic devices include one or more airborne agents, one or more local data centers, the cloud, and additional electronic devices that are communicatively coupled with each other. Thus, while portions of process 530 are described herein as being performed by particular devices, it will be appreciated that process 530 is not so limited. In process 530, some blocks are, optionally, combined, the order of some blocks is, optionally, changed, and some blocks are, optionally, omitted. In some examples, additional steps may be performed in combination with the process 530. Accordingly, the operations as illustrated (and described in greater detail below) are exemplary by nature and, as such, should not be viewed as limiting.

As shown in FIG. 5B, after receiving sensor data (e.g., LiDAR scans, color images), the system attempts to align the sensor data to an existing high-fidelity map 532. In some embodiments, the alignment is performed by matching the high-fidelity map 532 and the sensor data in a registration process. The system then generates a value representing an alignment error. The system then determines whether the alignment error exceeds a predefined threshold. A large alignment error indicates that there is significant update in the map (e.g., new traffic signs, new land marks, new roads). Thus, if the alignment error exceeds the threshold, the system aggregates the sensor data to the high-fidelity map to update the high-fidelity map. Processing of the sensor data can be performed using methods similar to those described with reference to FIG. 5A. If, on the other hand, the alignment error does not exceed the threshold, the system discards the data.

FIG. 5C depicts an exemplary process 540 for selecting gathered data for further processing to detect dynamic objects, in accordance with some embodiments. Process 540 can be performed, for example, during or after the flight of the airborne agents. Process 540 is performed, for example, using one or more electronic devices. In some examples, the blocks of process 540 are divided up in any manner among the one or more electronic devices performing process 540. In some examples, the one or more electronic devices include one or more airborne agents, one or more local data centers, the cloud, and additional electronic devices that are communicatively coupled with each other. Thus, while portions of process 540 are described herein as being performed by particular devices, it will be appreciated that process 530 is not so limited. In process 540, some blocks are, optionally, combined, the order of some blocks is, optionally, changed, and some blocks are, optionally, omitted. In some examples, additional steps may be performed in combination with the process 540. Accordingly, the operations as illustrated (and described in greater detail below) are exemplary by nature and, as such, should not be viewed as limiting.

As shown in FIG. 5C, the system receives data (e.g., videos captured by airborne agents). Based on the 2D data, the system detects a road map and moving objects. The detected road map can be used to align the moving objects with a high-fidelity map such that high-fidelity locations of the moving objects can be determined. The system determines whether the detected moving objects are of interest. A moving object is of interest if, for example, it is specified in the user's data request (e.g., a moving Toyota Camry when the user has requested data related to behaviors of Toyota Camry). If the detected moving objects are not of interest, the system foregoes further processing the data. If, on the other hand, the detected moving objects are of interest, the system proceeds to further processing the data. In some embodiments, the detection and determination are performed by the airborne agents, the local data centers, or a combination thereof, and further processing the data comprises sending the data to a server (e.g., a video data server at a local data center). In some embodiments, the data is clustered and compressed before being sent to a server. In some embodiments, the process 500, the process 530, the process 540, and the processes performed by the video data server are part of a data processing pipeline (e.g., the data processing pipeline of FIG. 1).

In some embodiments, the system detects dynamic scenarios from the gathered data. In the context of traffic scenarios, dynamic scenarios can include accidents (e.g., collisions), traffic conditions (e.g., traffic jams), abnormal activities (e.g., traffic violations). In some embodiments, the system detects the dynamic scenarios even if they are not data explicitly requested by the user. For example, the system can detect a traffic jam in a geographical region in real time and issue alerts to vehicles in the region. As another example, the system can actively respond to the detected event by deploying emergency supplies using the airborne agents. As another example, the system can detect a car's behavior when getting around a street cleaning vehicle as a traffic violation and flag the abnormal behavior to the user. These special/abnormal behaviors can be used to train autonomous vehicles.

Additional exemplary systems and methods for efficiently and accurately generating a high-fidelity three-dimensional representation of a physical environment that can include dynamic objects and scenarios are provided in U.S. Provisional Patent Application Ser. 62/727,986, entitled “INTELLIGENT CAPTURING OF A DYNAMIC PHYSICAL ENVIRONMENT,” filed Sep. 6, 2018, the content of which is hereby incorporated by reference in its entirety for all purposes.

Turning back to FIG. 2, at block 214, the system may determine that additional data needs to be gathered, and proceed back to block 208 to gather additional data. The system may need additional data, for example, if the system is unable to extract sufficient data of interest from the gathered data.

At block 222, the system provides an output based on the extracted data. In some embodiments, the user can access a web portal (e.g., the web portal 102 of FIG. 1) to access the requested data. For example, the user can use the web portal to specify a geographical region (e.g., from a search bar or from the map interface). For the specified geographical region, the web portal allows the user to view a variety of data. With reference to FIG. 3B, the web portal can provide: 3D world view (including down-sampled point cloud and original-resolution point cloud), 3D map layers (including down-sampled point cloud, dynamic objects, and semantic map), 2D map layers (including orthographic color image and digital surf ace model), video layer (including LiDAR scan video, color video, and sensor fused video), and base map layers (including satellite images and terrain map).

FIGS. 3C-J depict additional exemplary user interfaces for displaying data provided by the system. FIG. 3C depicts an exemplary view 330 of a down-sampled point cloud for a geographical region. The web portal allows the user to interact with the view 330 by, for example, zooming in, zooming out, and changing viewing angle. FIG. 3D depicts a portion of the view 330 after the user has zoomed in and changed the viewing angle.

FIG. 3E depicts an exemplary view 334 of an original-resolution point cloud for a geographical region. The web portal allows the user to interact with the view 334 by, for example, zooming in, zooming out, and changing viewing angle. FIG. 3F depicts a portion of the view 334 after the user has zoomed in and changed the viewing angle.

FIG. 3G depicts an exemplary view 336 of a 2D down-sampled point cloud for a specified geographical region 338. The web portal allows the user to interact with the view 336 by, for example, zooming in, zooming out, and changing viewing angle. In addition, the web portal can display animations of captured dynamic objects when the user selects “Dynamic objects”, as shown in FIG. 3H.

With reference to FIG. 3I, the web portal can display a semantic map showing the color-coded semantic types that the system has detected in the geographical region 338, such as intersections (indicated by color blocks), boundaries (e.g., beginnings, ends, edges) of roads or road segments (indicated by purple lines), lane markings (indicated by green lines), and available associated information such as speed limit, permissible turns (indicated by red dots). Further, when the user turns on “Satellite images” under Base map layers on the menu (not shown), the web portal displays the semantic map overlaid on satellite images of the geographical region.

In some embodiments, after the user submits a data request, the system can provide a status of the data request on the web portal. For example, the web portal can display progress information (e.g., percentage of necessary data gathered), time estimate, and/or information about the activities of the airborne agents (e.g., their locations). Further, the web portal allows the user to submit follow-up requests. For example, the web portal can allow the user to request additional data for a geographical region (e.g., to patch up a hole in the map), to request additional processing to the data (e.g., to obtain annotations of lane markings), or to request exporting of the data (e.g., to a training algorithm). In some embodiments, when the data request is submitted by a robot user, the system automatically transmits the data of interest to the robot user.

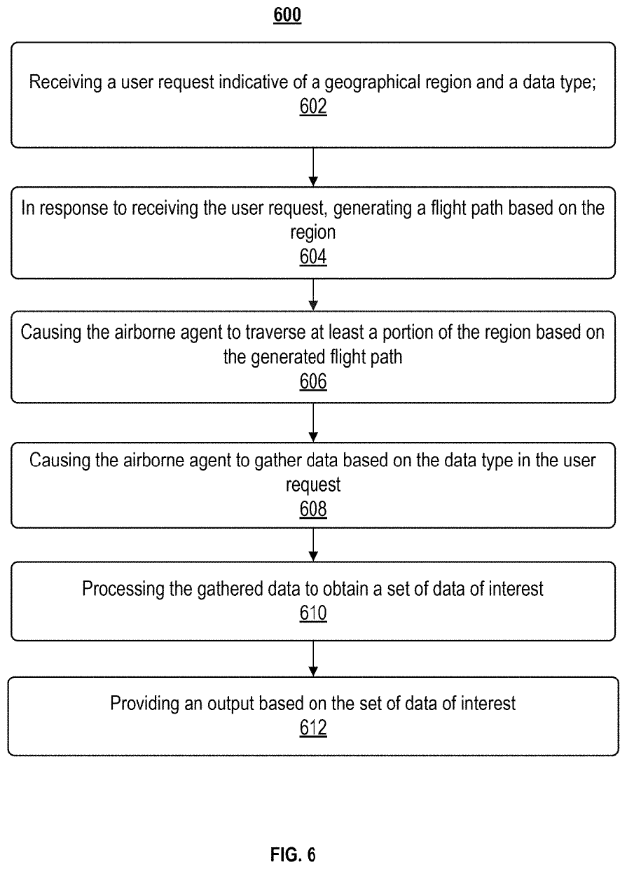

FIG. 6 illustrates process 600 for deploying an airborne agent to capture data related to a physical environment, according to various examples. Process 600 is performed, for example, using one or more electronic devices, and the blocks of process 600 are divided up in any manner between the electronic devices. Thus, while portions of process 600 are described herein as being performed by particular devices, it will be appreciated that process 600 is not so limited. In process 600, some blocks are, optionally, combined, the order of some blocks is, optionally, changed, and some blocks are, optionally, omitted. In some examples, additional steps may be performed in combination with the process 600. Accordingly, the operations as illustrated (and described in greater detail below) are exemplary by nature and, as such, should not be viewed as limiting.

At block 602, the system receives a user request indicative of a geographical region and a data type. At block 604, the system, in response to receiving the user request, generates a flight path based on the region. At block 606, the system causes the airborne agent to traverse at least a portion of the region based on the generated flight path. At block 608, the system causes the airborne agent to gather data based on the data type in the user request. At block 610, the system processes the gathered data to obtain a set of data of interest. At block 612, the system provides an output based on the set of data of interest.

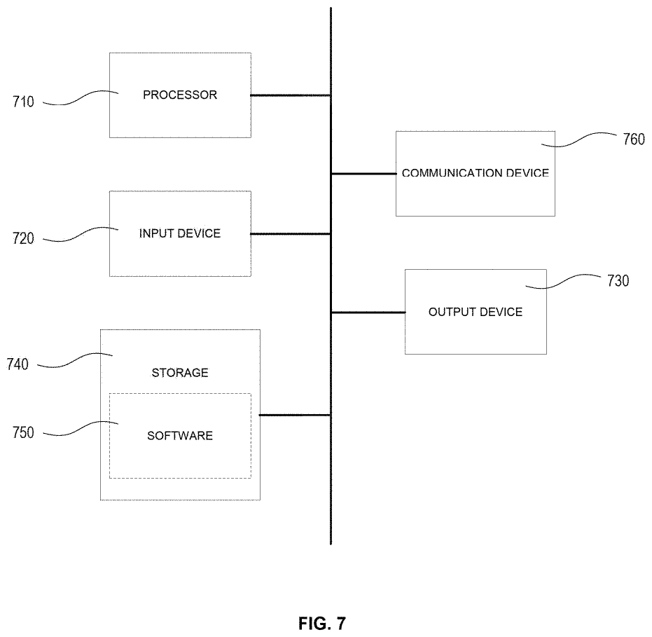

The operations described above with reference to FIG. 6 are optionally implemented by components depicted in FIG. 7. FIG. 7 illustrates an example of a computing device in accordance with one embodiment. Device 700 can be a host computer connected to a network. Device 700 can be a client computer or a server. As shown in FIG. 7, device 700 can be any suitable type of microprocessor-based device, such as a personal computer, workstation, server or handheld computing device (portable electronic device) such as a phone or tablet. The device can include, for example, one or more of processor 710, input device 720, output device 730, storage 740, and communication device 760. Input device 720 and output device 730 can generally correspond to those described above, and can either be connectable or integrated with the computer.

Input device 720 can be any suitable device that provides input, such as a touch screen, keyboard or keypad, mouse, or voice-recognition device. Output device 730 can be any suitable device that provides output, such as a touch screen, haptics device, or speaker.

Storage 740 can be any suitable device that provides storage, such as an electrical, magnetic or optical memory including a RAM, cache, hard drive, or removable storage disk. Communication device 760 can include any suitable device capable of transmitting and receiving signals over a network, such as a network interface chip or device. The components of the computer can be connected in any suitable manner, such as via a physical bus or wirelessly.

Software 750, which can be stored in storage 740 and executed by processor 710, can include, for example, the programming that embodies the functionality of the present disclosure (e.g., as embodied in the devices as described above).

Software 750 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 740, that can contain or store programming for use by or in connection with an instruction execution system, apparatus, or device.

Software 750 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate or transport programming for use by or in connection with an instruction execution system, apparatus, or device. The transport readable medium can include, but is not limited to, an electronic, magnetic, optical, electromagnetic or infrared wired or wireless propagation medium.

Device 700 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 700 can implement any operating system suitable for operating on the network. Software 750 can be written in any suitable programming language, such as C, C++, Java or Python. In various embodiments, application software embodying the functionality of the present disclosure can be deployed in different configurations, such as in a client/server arrangement or through a Web browser as a Web-based application or Web service, for example.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

What is claimed is:

1. A computer-enabled method for deploying an airborne agent to capture data related to a physical environment, the method comprising:
receiving a user request indicative of a geographical region and a data type;
in response to receiving the user request, generating a flight path based on the geographical region;
causing the airborne agent to traverse at least a portion of the geographical region based on the generated flight path;
causing the airborne agent to gather data based on the data type in the user request;
processing the gathered data to obtain a set of data of interest; and
providing an output based on the set of data of interest.

2. The method according to claim 1, wherein the data type is directed to one or more geographical characteristics of the region.

3. The method according to claim 1, wherein the data type is directed to one or more dynamic objects in the geographical region.

4. The method according to claim 1, wherein the data type is directed to one or more dynamic events in the geographical region.

5. The method according to claim 1, wherein generating the flight path based on the geographical region comprises:
obtaining a ground map based on the geographical region;
extracting a loop in the geographical region;
calculating, based on an altitude value and a camera-specific value, a buffer width for the extracted loop;
based on the calculated buffer width, generating a way point; and
generating a flight path comprising the way point.

6. The method according to claim 1, wherein the airborne agent is a drone.

7. The method according to claim 1, wherein processing the gathered data comprises: aggregating one or more point cloud scans, one or more color images, and one or more navigation signals to obtain a colorized and geo-referenced point cloud.

8. The method according of claim 7, further comprising: based on the colorized and geo-referenced point cloud, obtaining one or more semantic masks.

9. The method according to claim 1, wherein processing the gathered data comprises: selecting a subset of the gathered data for further processing in accordance with a determination that an alignment error exceeds a predetermined threshold.

10. The method according to claim 1, wherein processing the gathered data comprises: selecting a subset of the gathered data for further processing in accordance with a determination that a detected dynamic object is a dynamic object of interest.

11. An electronic device, comprising:
one or more processors;
a memory; and
one or more programs, wherein the one or more programs are stored in the memory and configured to be executed by the one or more processors, the one or more programs including instructions for:
receiving a user request indicative of a geographical region and a data type;
in response to receiving the user request, generating a flight path based on the geographical region;
causing the airborne agent to traverse at least a portion of the geographical region based on the generated flight path;
causing the airborne agent to gather data based on the data type in the user request;
processing the gathered data to obtain a set of data of interest; and
providing an output based on the set of data of interest.

12. A non-transitory computer-readable storage medium storing one or more programs, the one or more programs comprising instructions, which when executed by one or more processors of an electronic device having a display, cause the electronic device to:
receive a user request indicative of a geographical region and a data type;
in response to receiving the user request, generate a flight path based on the geographical region;
cause the airborne agent to traverse at least a portion of the geographical region based on the generated flight path;
cause the airborne agent to gather data based on the data type in the user request;
process the gathered data to obtain a set of data of interest; and
provide an output based on the set of data of interest.
